(19) United States
(12) Patent Application Publication
(10) Pub. No.: US 2015/0262313 A1
(43) Pub. Date: Sep. 17, 2015

(54) MULTIPLICATIVE INCENTIVE MECHANISMS

(71) Applicant: Microsoft Corporation, Redmond, WA (US)

(72) Inventors: Nihar Bhadresh Shah, Berkeley, CA (US); Dengyong Zhou, Redmond, WA (US)

(73) Assignee: Microsoft Corporation, Redmond, WA (US)

(21) Appl. No.: 14/207,154

(22) Filed: Mar. 12, 2014

(51) Int. Cl. G06Q 50/00; G06F 3/0484; G06Q 30/02; G06F 3/0482

(52) U.S. Cl. CPC G06Q 50/01; G06F 3/0482; G06F 3/04842; G06Q 30/0206; G06Q 30/0203

(57) ABSTRACT

A user interface may include instructions to complete a task (including a plurality of task items) and rule(s) that indicate to a worker how a payment associated with the task is to be calculated. The worker may provide information associated with the individual task items via the user interface. The payment may be calculated based on the rule(s), where the payment is determined based at least in part on a multiplicative payment component. In some implementations, the user interface may include an option for the worker to skip question(s), and the worker may be incentivized to skip question(s) when the worker does not know the answer. Further, in some implementations, the user interface may allow the worker to specify a confidence value when the worker chooses to answer the question, and the worker may be incentivized to provide an accurate confidence value.

### BACKGROUND

In a crowdsourcing setup, a “requester” has a task to be performed, which may include a set of questions to be answered. The requester may load the task onto a crowdsourcing platform and may offer a certain payment for this task to be done. At least one other person (often referred to as “crowdsourcing workers” or simply “workers”) may then perform the task in exchange for the promised amount. However, such workers may not be experts, may be careless, or may answer questions hastily, and hence their work may be of poor quality. Further, some workers may not have good intent (e.g., may be a spammer or a miscreant) and may intentionally provide poor quality and/or erroneous data, for a variety of reasons. Typically, in order to address the issue of poor work quality, the task may be performed by multiple workers, and the responses from all of the workers may be aggregated by the requester to produce a final solution.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Some implementations provide techniques and arrangements for incentivizing one or more “workers” to provide high quality data for a particular task using one or more multiplicative payment mechanisms. In some cases, the workers may include crowdsourcing workers, and the task may be defined by a requester and presented to the workers via a crowdsourcing platform.

In some implementations, a multiplicative incentive mechanism may be used to improve data accuracy by incentivizing a worker to skip question(s) when the worker does not know the answer to the question(s).

In some implementations, a multiplicative incentive mechanism may be used to improve data accuracy by not only incentivizing a worker to skip question(s) when the worker does not know the answer to the question(s) but also incentivizing a worker to provide an accurate assessment of the worker's confidence in a particular answer when the worker chooses to answer a question.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items or features.

FIGS. 1 and 2 illustrate a sequence of views of an example user interface associated with an application (e.g., a “crowdsourcing” application) that may utilize a particular multiplicative incentive mechanism, according to some implementations.

FIG. 3 illustrates an example user interface to provide a user with information regarding a payment calculation according to the particular multiplicative incentive mechanism of FIGS. 1 and 2, according to some implementations.

FIG. 4 illustrates an example user interface associated with an application (e.g., a “crowdsourcing” application) that may utilize another multiplicative incentive mechanism that may improve accuracy by incentivizing a worker to skip questions when the worker does not know the answer, according to some implementations.

FIG. 5 illustrates an example user interface to provide a user with information regarding a payment calculation according to the particular multiplicative incentive mechanism of FIG. 4 (that includes the skip option), according to some implementations.

FIG. 6 illustrates an example user interface associated with an application (e.g., a “crowdsourcing” application) that may utilize another multiplicative incentive mechanism that may improve accuracy by incentivizing a worker to skip question(s) when the worker does not know the answer and to provide a confidence value when the worker chooses to answer the question, according to some implementations.

FIG. 7 illustrates an example user interface to provide a user with information regarding a payment calculation according to the particular multiplicative incentive mechanism of FIG. 6 (that includes the skip option and confidence indication), according to some implementations.

FIGS. 8-10 illustrate process flows associated with example embodiments of multiplicative incentive mechanisms, according to some implementations.

FIG. 11 illustrates an example computing device and system environment in which some implementations may operate.

### DETAILED DESCRIPTION

The present disclosure relates to multiplicative incentive mechanisms that may be used to obtain high quality data from a group of workers (e.g., from crowdsourcing workers in a crowdsourcing context). In a crowdsourcing setting, various types of workers may attempt to perform a particular task. One type of worker may have good intent and may want to do good work. However, such workers may not be “experts” or otherwise competent to perform the particular task and may provide poor quality and/or erroneous data. Another type of worker may not have good intent (e.g., a spammer or a miscreant) and may intentionally provide poor quality and/or erroneous data, for a variety of reasons. The multiplicative incentive mechanisms described herein may balance the worker's desire to maximize her payment with the requester's desire to obtain high quality data.

In a typical crowdsourcing scenario, a requester may pose questions to crowdsourcing workers that may relate to, for example, labeling (e.g., labeling a set of items to be used for training a machine learning model). As one illustrative non-limiting example, the requester may have a set of web pages to be labeled by the crowdsourcing workers as spam or non-spam. As another illustrative non-limiting example, the requester may have a set of query-URL pairs to be labeled with different relevance levels (e.g., perfect, excellent, good, fair, or bad, among other alternatives). In typical crowdsourcing implementations, the requester may simply pay a particular worker based on a number of tasks that the particular worker has completed. To illustrate, the requester may typically pay a certain amount (e.g., two cents) for labeling multiple (e.g., ten) images, regardless of label quality.

In the present disclosure, one or more incentive mechanisms are described that may improve the quality of answers that the workers provide. For example, an incentive may include money, points, or social status, among other alternatives. In a particular embodiment, a multiplicative incentive mechanism may provide the worker with an option to skip a question if she is not sure about the answer. In some embodiments, in addition to or instead of allowing the worker to skip the question, a multiplicative incentive mechanism may prompt the worker to provide a confidence value for each question that the worker answers. The option of skipping a question may reduce the number of random answers, while the confidence value may provide a better sense of how much “weight” to assign to a particular answer in order to improve the quality of the answers.

The multiplicative incentive mechanisms described herein may encourage a worker to be honest and thoughtful about how they answer the questions. In some embodiments, a worker may be incentivized to skip a question when the worker is not “confident enough” in the answer, rather than guess (and possibly reduce overall data quality). In some embodiments, a worker may be incentivized to provide an honest assessment of her confidence level for a particular answer. The multiplicative incentive mechanisms described herein may significantly improve the quality of answers received from crowdsourcing workers.

### Example Implementations

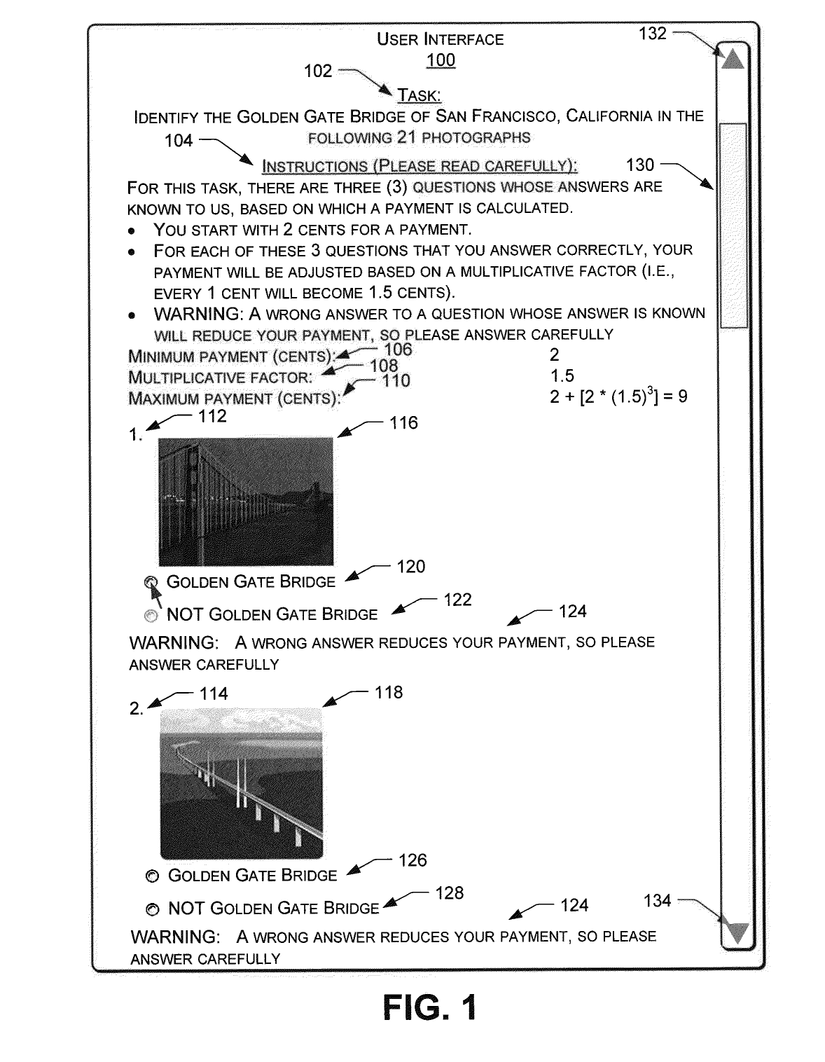

FIG. 1 illustrates an example of a user interface 100 associated with an application (e.g., a “crowdsourcing” application), according to some implementations. In some cases, a requester may define a crowdsourcing task that may include a set of multiple choice questions to be solved by crowdsourcing workers. While not specifically illustrated in FIG. 1, in some cases, the requester may utilize a crowdsourcing platform to make the multiple choice questions accessible to the workers over a network (e.g., the Internet). Further, the requester may specify how a worker is to be compensated (e.g., money, points, etc.) in exchange for the worker performing the task. For illustrative purposes only, FIG. 1 illustrates an example of a task 102 that includes a worker identifying the Golden Gate Bridge of San Francisco, Calif. in multiple photographs (e.g., 21 photographs in the particular example of FIG. 1).

While the task 102 illustrated in FIG. 1 includes identifying photographs, the multiplicative incentive mechanisms of the present disclosure may be applied in various alternative tasks and task solving contexts, including but not limited to crowdsourcing applications. In general, the task to be performed by one or more workers may represent a problem to be solved by one or more humans, rather than by one or more machines. To illustrate, the task may include identifying license plate information, translating text, transcribing text (e.g., from an old book that may be difficult for a machine to read), analyzing data (e.g., determining a mood of a person based on one or more micro-blog feeds, social networking posts, etc.), or solving mathematical problem(s), among other alternatives.

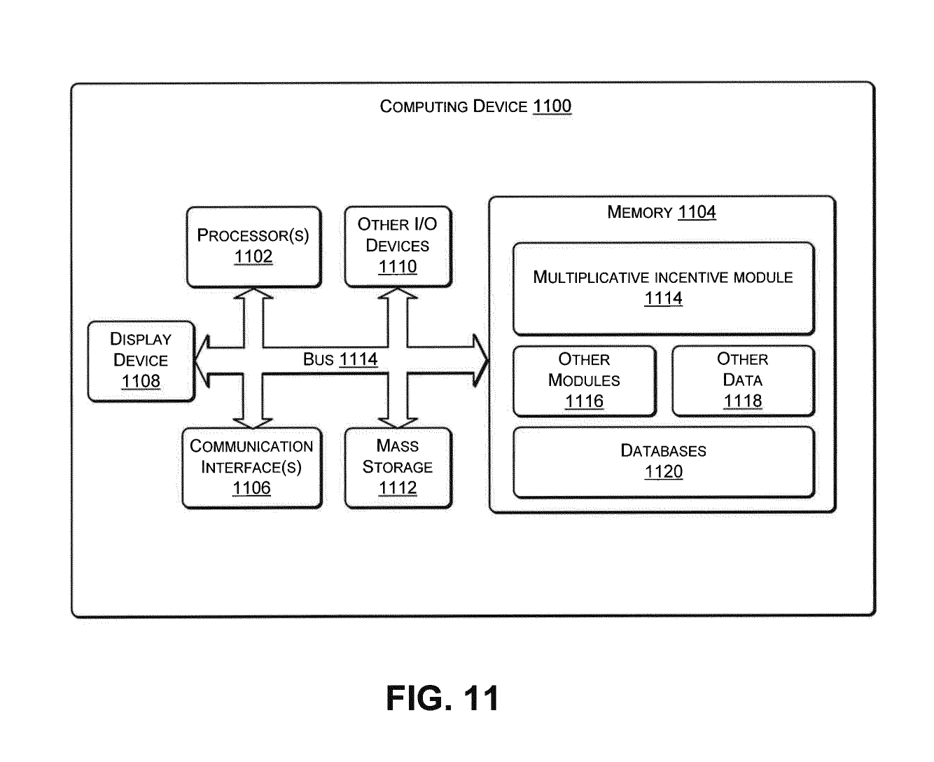

In some cases, the user interfaces of the present disclosure (e.g., the user interface 100) may be displayed via a computing device (e.g., on the display device 1108 of the computing device 1100 of FIG. 11 described below). The user interface 100 may allow a worker to view instructions 104 that are associated with the task 102 (e.g., instructions provided by the requester when loading the task 102 onto a crowdsourcing platform). In the example of FIG. 1, the instructions 104 indicate that there are three questions whose answers are known, and that a payment to the worker is based at least in part on the answers to these questions. Questions with an answer that is known (or that may be ascertained) are referred to herein as “gold standard” questions. In some cases, a “gold standard” question may be based on “a priori” information, a super-majority of workers providing the same answer, or even information that is not yet known but later becomes known. As an illustrative example, a question may include “Who will win the next elections?” with payment delayed until the event happens. In some embodiments, the “gold standard” questions may be inserted randomly into the sequence of questions presented to the worker.

The instructions 104 further indicate that, for each “gold standard” question that the worker answers correctly, the payment may be adjusted based on a multiplicative factor 108. In some cases, a minimum payment 106 may be zero or non-zero. For example, a crowdsourcing platform may specify that the minimum payment 106 be greater than zero in order for the requester to post the task 102 for completion by crowdsourcing workers. Thus, when the minimum payment 106 is greater than zero, the total payment to the worker upon completion of the task 102 may include the minimum payment 106 and an optional “incentive” payment. As such, in some cases, the “incentive” payment may be adjusted based on the multiplicative factor 108.

FIG. 1 further illustrates that the instructions 104 include a warning to the worker that a wrong answer to a question whose answer is known (i.e., one of the three “gold standard” questions in the exemplary task 102) will reduce the payment to the worker. To illustrate, in some embodiments, the payment may be reduced by a significant factor, to the minimum payment 106, or to zero (e.g., in cases where a crowdsourcing platform allows the requester to post a task with a minimum payment of zero). This warning may incentivize the worker to carefully answer each question. Further, the warning may discourage some spammers or other miscreants from performing the task 102, as such “workers” may determine based on the warning that there is a high likelihood of random guessing resulting in a significantly reduced payment to the worker or zero payment to the worker.

In the example of FIG. 1, for each “gold standard” question that the worker answers correctly, the payment may be adjusted by multiplying a starting payment amount (e.g., two cents) by the multiplicative factor 108 (e.g., 1.5 in the particular embodiment illustrated in FIG. 1), up to a maximum payment 110 corresponding to 2+[2*(1.5)^{N}], where N corresponds to the number of “gold standard” questions answered correctly. Thus, FIG. 1 illustrates a “multiplicative incentive mechanism” that is based at least in part on a multiplicative component.

The user interface 100 of FIG. 1 shows a first question 112 and a second question 114 (out of a total of 21 photograph identification questions associated with the task 102). In the example of FIG. 1, the first question 112 includes a first image 116 of a bridge, and the second question 114 includes a second image 118 of a bridge. In the embodiment illustrated in FIG. 1, the first question 112 includes a first selectable answer 120 (i.e., “Golden Gate Bridge”) and a second selectable answer 122 (i.e., “NOT Golden Gate Bridge”). In the embodiment illustrated in FIG. 1, the first question 112 also includes a warning 124 to indicate to the worker that “a wrong answer may reduce your payment, so please answer carefully.”

The second question 114 includes a first selectable answer 126 (i.e., “Golden Gate Bridge”) and a second selectable answer 128 (i.e., “NOT Golden Gate Bridge”). FIG. 1 also illustrates that the second question 114 may also include the warning 124 to indicate to the worker that “a wrong answer may reduce your payment, so please answer carefully.”

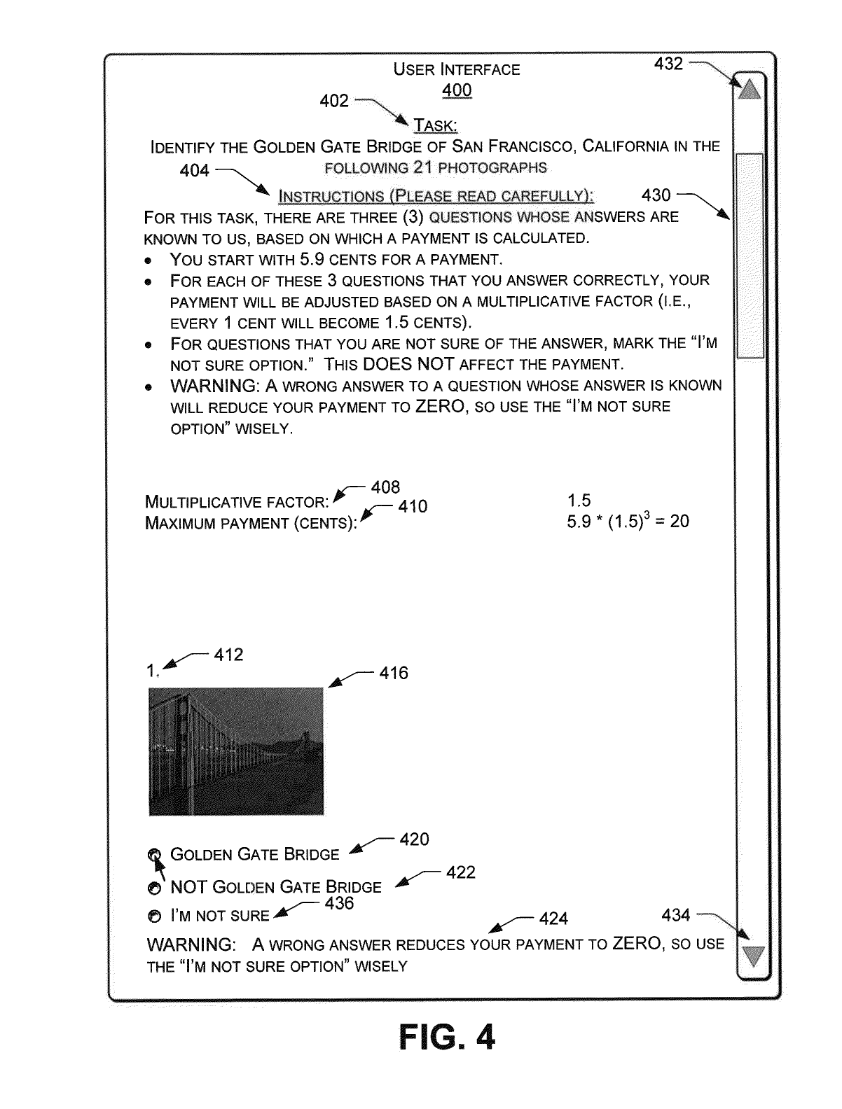

FIG. 1 illustrates a multiple choice question format that corresponds to a true/false question format (i.e., “Golden Gate Bridge” corresponds to true, while “NOT Golden Gate Bridge” corresponds to false). In alternative embodiments, the first question 112 and/or the second question 114 may be presented in alternative ways. For example, the first question 112 and/or the second question 114 may prompt the worker to answer the question “Is this the Golden Gate Bridge?” (among other alternatives). In this illustrative example, the first selectable answer 120 may be “true” or “yes,” while the second selectable answer 122 may be “false” or “no.” As described further below, in alternative embodiments, one or more questions presented to a worker may include alternative numbers of selectable answers (see e.g., the “I'm not sure” answer in FIG. 4). Thus, FIG. 1 represents an illustrative, non-limiting example of how the task 102 may be presented to the worker via the user interface 100.

In the embodiment illustrated in FIG. 1, the user interface 100 includes a navigation bar 130, a first selectable control 132 to “scroll up” and a second selectable control 134 to “scroll down” (e.g., to view other questions that follow the second question 114). The worker may use the navigation bar 130, the first selectable control 132, the second selectable control 134, or a combination thereof in order to view and provide answers to each of the 21 questions that are associated with the task 102.

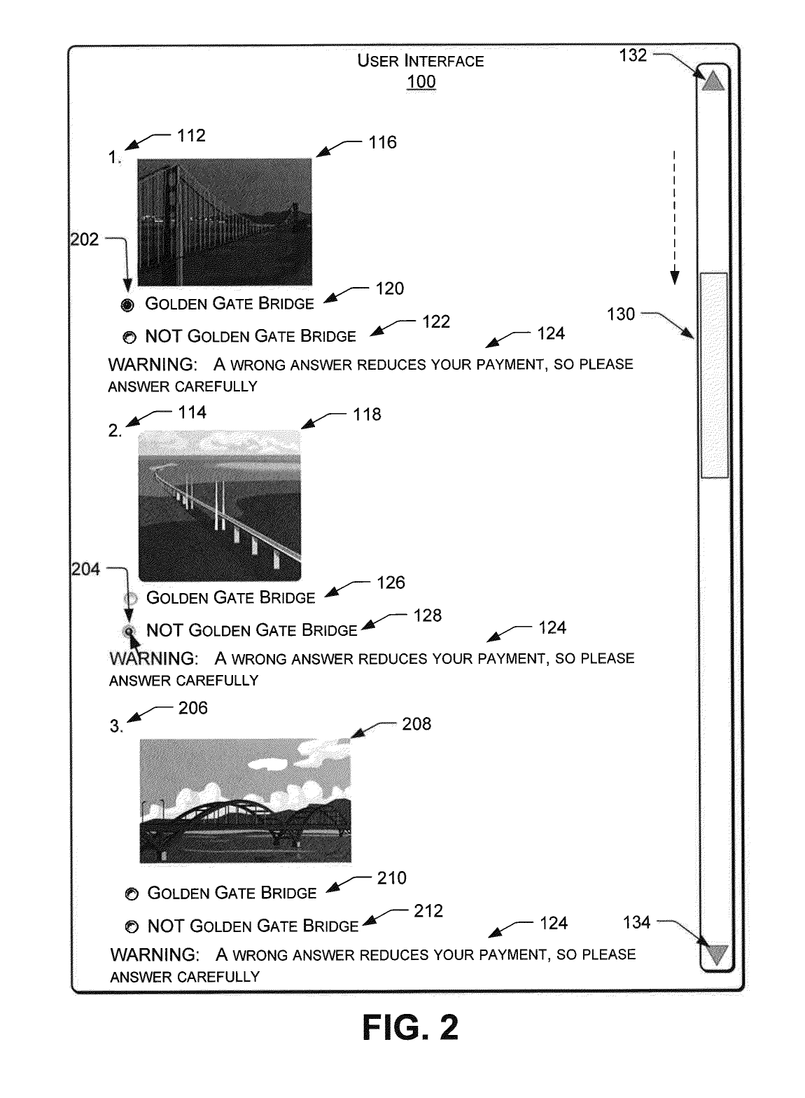

FIG. 2 illustrates the user interface 100 of FIG. 1 after the worker has selected the first selectable answer 120 (i.e., “Golden Gate Bridge”) to the first question 112, as shown at 202. FIG. 2 further illustrates that the worker has selected the second selectable answer 128 (i.e., “NOT Golden Gate Bridge”) to the second question 114, as shown at 204. FIG. 2 also illustrates that the worker has scrolled down (e.g., via the navigation bar 130 or the second selectable control 134) such that a third question 206 is displayed.

In the example of FIG. 2, the third question 206 includes a first selectable answer 210 (i.e., “Golden Gate Bridge”) and a second selectable answer 212 (i.e., “NOT Golden Gate Bridge”). In the embodiment illustrated in FIG. 2, the third question 206 also includes the warning 124 to indicate to the worker that “a wrong answer may reduce your payment, so please answer carefully.” In alternative embodiments, the third question 206 may be presented in alternative ways. For example, the third question 206 may prompt the worker to answer the question “Is this the Golden Gate Bridge?” (among other alternatives). In this illustrative example, the first selectable answer 210 may be “true” or “yes,” while the second selectable answer 212 may be “false” or “no.” While not shown in FIG. 2, the worker may select either the first selectable answer 210 or the second selectable answer 212 and may scroll down (e.g., via the navigation bar 130 or the second selectable control 134) in order to complete all 21 questions associated with the task 102. Further, the worker may scroll up (e.g., via the navigation bar 130 or the first selectable control 132) to return to a particular question or review answers prior to submission.

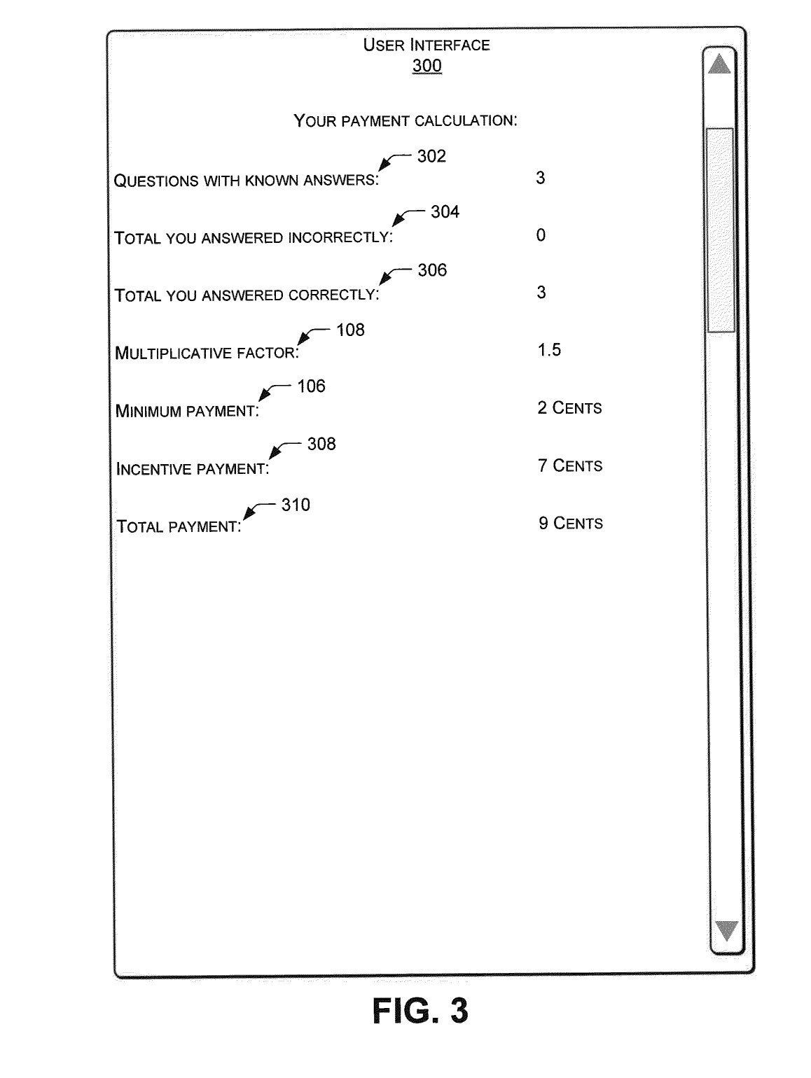

Referring to FIG. 3, an example of a user interface 300 that may be presented after completion of the task 102 is illustrated. The user interface 300 may provide information to the worker regarding the payment associated with the task 102.

In the embodiment illustrated in FIG. 3, the user interface 300 identifies the number of questions with known answers that are associated with the task 102 (i.e., the “gold standard” questions), as shown at 302. In this case, the number of “gold standard” questions is three. The user interface 300 also identifies a number of “gold standard” questions that the worker answered incorrectly, as shown at 304. For illustrative purposes only, FIG. 3 shows that the worker has answered none of the three “gold standard” questions incorrectly. The user interface 300 also identifies a number of “gold standard” questions that the worker answered correctly, as shown at 306. For illustrative purposes only, FIG. 3 shows that the worker has answered all three “gold standard” questions correctly.

As indicated in the instructions 104 associated with the task 102 (see FIG. 1), a payment to the worker may be determined based on the number of “gold standard” questions that the worker answered correctly (i.e., three in the example of FIG. 3) and the multiplicative factor 108 (e.g., 1.5). Further, in the particular embodiment illustrated in FIG. 3, the worker may receive the minimum payment 106 (e.g., two cents) regardless of the number of “gold standard” questions that the worker answered correctly. In alternative embodiments, the minimum payment 106 may be zero. Thus, in the example of FIG. 3, an incentive payment 308 is multiplicative and is determined based on the formula 2*(1.5)^{N}, where N corresponds to the number of “gold standard” questions answered correctly (i.e., 3 in this example), resulting in an incentive payment amount of seven cents (i.e., 2*(1.5)³ cents). A total payment 310 may be determined based on a combination of the minimum payment 106 (i.e., two cents in this case) and the incentive payment 308 (i.e., seven cents in this case), resulting in a total payment amount of 9 cents. Thus, in the example of FIG. 3, while the total payment 310 of 9 cents includes the minimum payment 106 of two cents, the total payment 310 is based at least in part on a multiplicative component (i.e., the seven cents associated with the incentive payment 308 determined based on the formula 2*(1.5)^{N}).

The present disclosure describes additional multiplicative incentive mechanisms to obtain high quality labels. In one embodiment, a multiplicative incentive mechanism includes a skip-based mechanism. In another embodiment, a multiplicative incentive mechanism includes a combination of a skip-based mechanism and a confidence-based mechanism.

FIG. 4 illustrates an example of a user interface 400 that may be associated with an application (e.g., a “crowdsourcing” application), according to some implementations. FIG. 4 illustrates a multiplicative incentive mechanism in which the worker is provided with an option to skip a question and is incentivized to skip the question and avoid “guessing” when she does not know the answer to the question, which may result in improved overall data quality for the requester. One incentive for the worker to skip a question rather than guess an answer to the question is that an incorrect answer to a “gold standard” question reduces the incentive payment (e.g., to zero or by a significant factor). In some embodiments, the “gold standard” questions may be inserted randomly, and the worker may not be able to determine which questions are the “gold standard” questions that affect her payment. Another incentive for the worker to skip a question rather than guess an answer to the question is that a skipped question does not reduce the payment. That is, the payment may be adjusted based on a multiplicative factor of one for skipped questions.

Referring to FIG. 4, an illustrative example of a task 402 includes a worker identifying the Golden Gate Bridge of San Francisco, Calif. in multiple photographs (e.g., 21 photographs in the particular embodiment of FIG. 4). In some cases, the user interface 400 may be displayed via a computing device (e.g., on the display device 1108 of the computing device 1100 of FIG. 11 described below). The user interface 400 may allow a worker to view instructions 404 that are associated with the task 402. In the example of FIG. 4, the instructions 404 indicate that there are three “gold standard” questions, and that a payment to the worker is based at least in part on the answers to these three “gold standard” questions.

The instructions 404 further indicate that, for each of the “gold standard” questions that the worker answers correctly, the payment may be adjusted based on a multiplicative factor 408. In contrast to FIG. 1, the instructions 404 indicate that the worker starts with a payment of 5.9 cents, which may be represented as K. In further contrast to FIG. 1, FIG. 4 illustrates an example in which a minimum payment to the worker may be zero. That is, an incorrect answer to one of the three “gold standard” questions may result in a payment to the worker being reduced to zero (or by a significant factor to incentivize the worker to refrain from “guessing”). In the particular embodiment illustrated in FIG. 4, the multiplicative factor 408 is 1.5. In this example, the payment is increased by 50% (i.e., multiplied by 1.5) for each “gold standard” question that the worker answers correctly, up to a maximum payment 410 corresponding to 5.9*(1.5)^{N}, where N corresponds to the number of “gold standard” questions answered correctly. Thus, FIG. 4 illustrates an alternative example of a multiplicative incentive mechanism that is based at least in part on a multiplicative component.

The user interface 400 of FIG. 4 shows a first question 412 (out of a total of 21 photograph identification questions associated with the task 402). In the example of FIG. 4, the first question 412 includes a first image 416 of a bridge, a first selectable answer 420 (i.e., “Golden Gate Bridge”), a second selectable answer 422 (i.e., “NOT Golden Gate Bridge”), and a selectable option 436 to skip the question (e.g., an “I'm not sure” option). Thus, in contrast to the example illustrated in FIG. 1, the worker is given the option to skip a particular question. Further, in the embodiment illustrated in FIG. 4, the first question 412 also includes a warning 424 to indicate to the worker that a wrong answer may reduce the payment to ZERO.

In the embodiment illustrated in FIG. 4, the user interface 400 includes a navigation bar 430, a first selectable control 432 to “scroll up” and a second selectable control 434 to “scroll down” (e.g., to view other questions that follow the first question 412). The worker may use the navigation bar 430, the first selectable control 432, the second selectable control 434, or a combination thereof in order to view and provide answers to each of the 21 questions that are associated with the task 402. Further, the worker may scroll up (e.g., via the navigation bar 430 or the first selectable control 432) to return to a particular question or review answers prior to submission.

In the example of FIG. 4, the multiplicative incentive mechanism is based on a multiplicative component with no additive portion associated with a minimum payment. That is, K may be reduced to zero in the event that the worker answers one the of “gold standard” questions incorrectly (in some cases, even if the incorrectly answered “gold standard” question was the third “gold standard” question, with the first two “gold standard” questions having been answered correctly).

In some embodiments, the three “gold standard” questions associated with the task 402 may be inserted randomly into the sequence of questions presented to the worker. Thus, the worker may have no way of knowing whether a particular question is a “gold standard” question. The exemplary multiplicative incentive mechanism of FIG. 4 may incentivize the worker to skip a particular question when the worker is not “confident enough” in the answer to justify the incentive payment being reduced to zero in the event that the worker answers the question incorrectly and the question is one of the “gold standard” questions.

As indicated in the instructions 404, a starting payment for the task 402 is 5.9 cents, which may be represented as K. However, the task 402 is not complete and no payment is made until the worker has selected one of the three available options for each of the 21 questions. Referring to the first question 412 as an example, the worker may answer the first question 412 by selecting the first selectable answer 420, answer the first question 412 by selecting the second selectable answer 422, or skip the question by selecting the selectable option 436 labeled “I'm not sure” in FIG. 4. The multiplicative incentive mechanism of the present disclosure incentivizes the worker to skip a question if her confidence is below a confidence threshold (represented as T) and to answer the question if her confidence is greater than T. For every correctly answered “gold standard” question, K may be multiplied by the multiplicative factor 408, which may correspond to 1/T. If the worker answers even one “gold standard” question incorrectly, K may be reduced to zero. In the present example, the worker is allowed to select one of three possible options for each question.

Referring to the first question 412 of FIG. 4 as an example, if the worker's confidence that the bridge illustrated in the first image 416 is the Golden Gate Bridge is above the confidence threshold T, the worker may answer the first question 412 by selecting the first selectable answer 420 (i.e., “Golden Gate Bridge”). Alternatively, if the worker's confidence that the bridge illustrated in the first image 416 is the Golden Gate Bridge is below the confidence threshold T, the worker may be incentivized to skip the first question 412 by selecting the selectable option 436 (i.e., “I'm not sure”).

For illustrative purposes only, the first question 412 of FIG. 4 may be one of the three “gold standard” questions associated with the task 402. In the event that the worker correctly answers the first question 412 by selecting the first selectable answer 420, the starting payment K (e.g., 5.9 cents in this case) may be multiplied by the multiplicative factor 408 (e.g., 1.5 in this case). That is, the payment may be adjusted from 5.9 cents to 8.9 cents (i.e., 5.9 cents*1.5=8.9 cents). In the event that the worker elects to skip the first question 412 by selecting the selectable option 436, the payment is not reduced. That is, the starting payment K (e.g., 5.9 cents in this case) may be adjusted by a second multiplicative factor (i.e., 1), resulting in the payment remaining at 5.9 cents. In the example illustrated in FIG. 4, most workers are likely to have a high confidence that the bridge illustrated in the first image 416 is indeed the Golden Gate Bridge. Accordingly, most workers would be incentivized to answer the first question 412 to increase their payment by 50 percent (i.e., 8.9 cents versus 5.9 cents). In the event that the worker incorrectly answers the first question 412 by selecting the second selectable answer 422, the starting payment K (e.g., 5.9 cents in this case) may be reduced to zero (or reduced by a significant factor in alternative embodiments). Thus, the multiplicative incentive mechanism may also discourage spammers or other miscreants from guessing or randomly selecting answers to questions, as the worker does not know which questions are the “gold standard” questions.

By contrast, referring back to FIG. 2 for illustrative purposes only, if the second question 114 presented to the worker was whether the bridge illustrated in the second image 118 is the Oresund Bridge in Sweden, many workers may not have a high confidence that the bridge illustrated in the second image 118 is in fact the Oresund Bridge in Sweden. Accordingly, most workers would be incentivized to skip the second question 114 to avoid the possibility of the payment K being reduced to zero (or reduced by a significant factor in alternative embodiments). However, some workers may be “experts” on bridges, may be “experts” on Sweden, or may happen to be located in Sweden and accordingly may have a high confidence that the bridge illustrated in the second image 118 is the Oresund Bridge in Sweden. Further, even if a worker was not initially confident in her answer, the multiplicative incentive mechanism of the present disclosure may motivate some workers (i.e., not spammers or miscreants) to actually perform research and improve her confidence level (e.g., by searching the Internet for images of the Oresund Bridge in Sweden for comparison) in order to answer the question and increase their payment by 50 percent.

Thus, the exemplary multiplicative incentive mechanism of FIG. 4 may encourage workers to be honest by incentivizing the workers to answer questions when they are confident that they know the answer and to skip questions when they are not confident that they know the answer. Further, the possibility of a significant reduction or elimination of the payment for incorrect answers may encourage workers to be more careful when answering questions and may discourage spammers or miscreants from performing a task. Still further, the multiplicative nature of the payment determination may encourage some workers to perform additional research in order to determine whether to answer or skip a particular question.

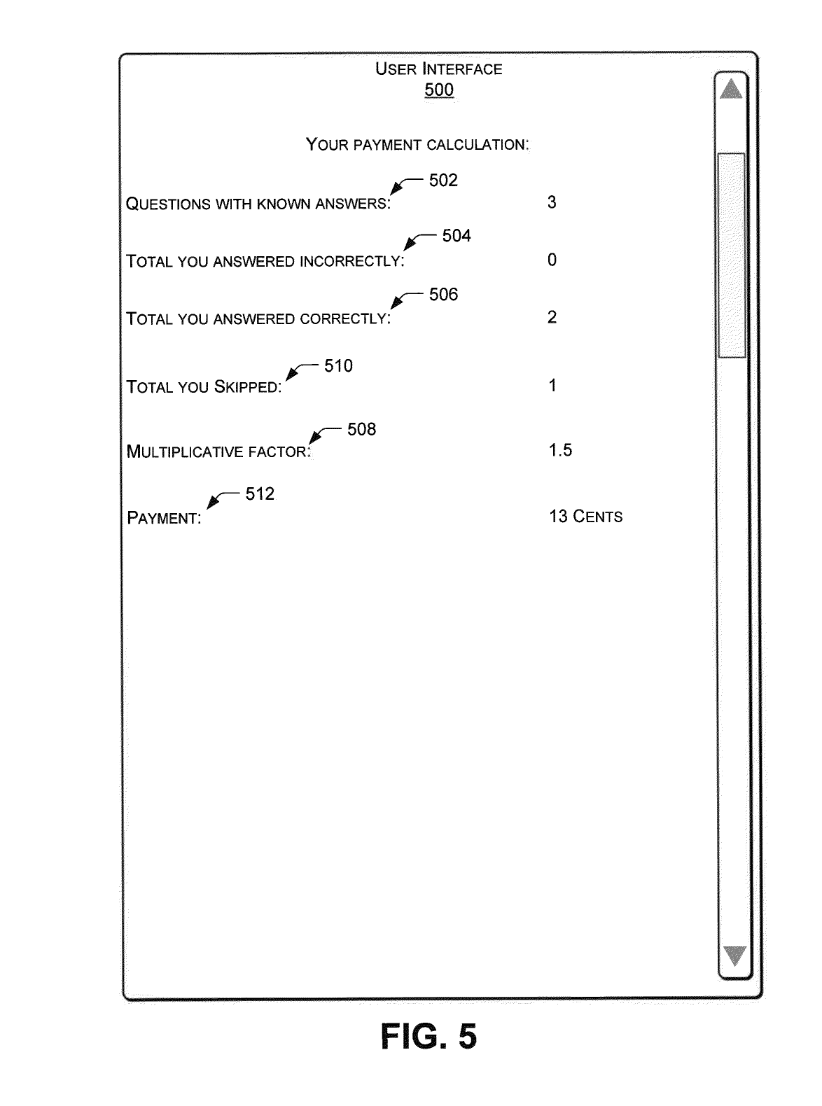

Referring to FIG. 5, an example of a user interface 500 that may be presented after completion of the task 402 in FIG. 4 is illustrated. The user interface 500 may provide information to the worker regarding the payment associated with the task 402.

In the embodiment illustrated in FIG. 5, the user interface 500 identifies a number of questions with known answers that are associated with the task 402 (i.e., the “gold standard” questions), as shown at 502. In this case, the number of “gold standard” questions is three. The user interface 500 also identifies a number of “gold standard” questions that the worker answered incorrectly, as shown at 504. For illustrative purposes only, FIG. 5 shows that the worker has answered none of the three “gold standard” questions incorrectly. The user interface 500 also identifies a number of “gold standard” questions that the worker answered correctly, as shown at 506. For illustrative purposes only, FIG. 5 shows that the worker has answered two of the three questions correctly.

As indicated in the instructions 404 associated with the task 402 (see FIG. 4), a payment to the worker may be determined based on the number of “gold standard” questions that the worker answered correctly (i.e., two in the example of FIG. 5) and the multiplicative factor 508 (e.g., 1.5). In contrast to the user interface 300 of FIG. 3, the user interface 500 of FIG. 5 also illustrates a number of skipped “gold standard” questions (i.e., the number of questions where the user selected the “I'm not sure” option 436 illustrated in FIG. 4), as shown at 510. For illustrative purposes only, FIG. 5 shows that the worker has skipped one of the three “gold standard” questions.

Further, in contrast to FIG. 3, FIG. 5 does not identify a minimum payment, as the payment could be zero in the event that the worker chose not to skip one of the “gold standard” questions and answered the question incorrectly. Thus, in the example of FIG. 5, a payment 512 is multiplicative and is determined based on the number of correctly answered “gold standard” questions (i.e., 2) using the multiplicative factor 508 (i.e., 5.9*1.5^{N}, with N being 2 in this case), resulting in a payment amount of 13 cents. Thus, in the example of FIG. 5, the payment 512 is based at least in part on a multiplicative component (i.e., the payment 512 does not include an additive component associated with a non-zero minimum payment).

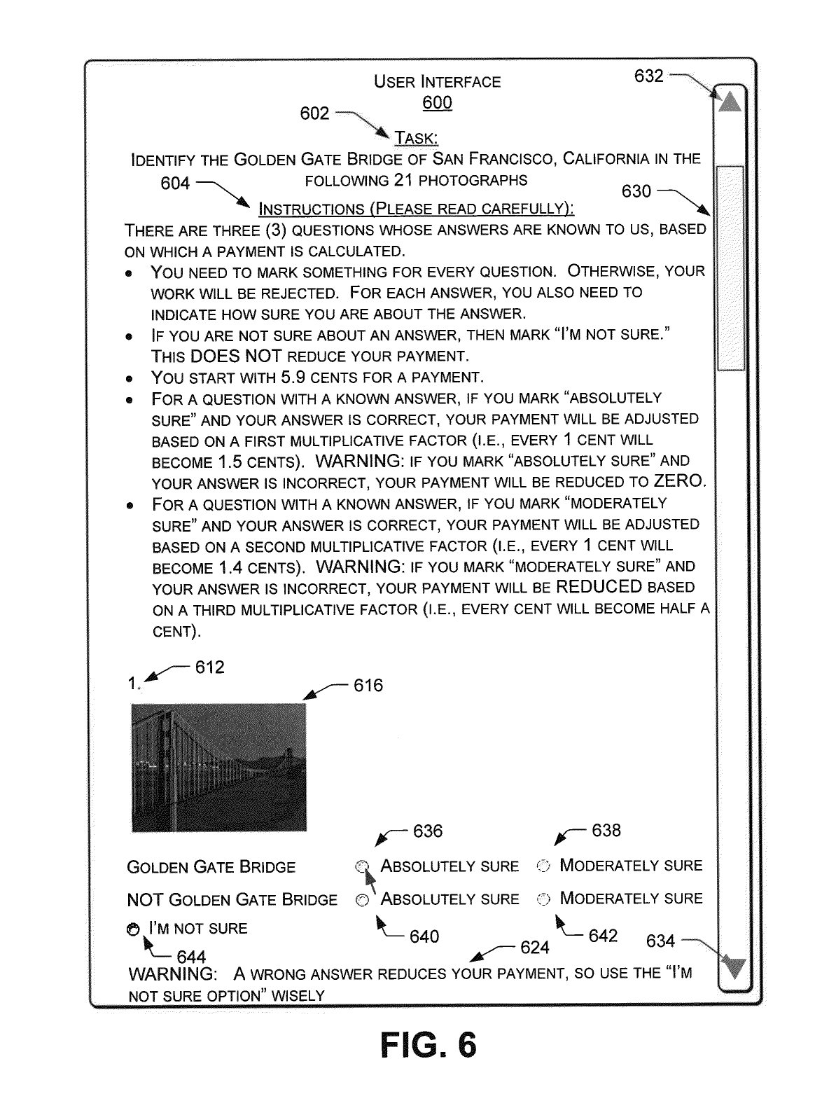

Referring to FIG. 6, an example of a user interface 600 that may be associated with an application (e.g., a “crowdsourcing” application) is illustrated, according to some implementations. FIG. 6 illustrates a multiplicative incentive mechanism in which the worker is provided with an option to skip a question and is incentivized to skip the question and avoid “guessing” when she does not know the answer to the question, which may result in improved overall data quality for the requester. FIG. 6 further illustrates that, in addition to the option to skip a question, the worker may provide a confidence level when answering the question.

As described above with respect to FIG. 4, one incentive for the worker to skip a question rather than guess an answer to the question is that an incorrect answer to a “gold standard” question reduces the incentive payment (e.g., to zero or by a significant factor). In some embodiments, the “gold standard” questions may be inserted randomly, and the worker may not be able to determine which questions are the “gold standard” questions that affect her payment. Another incentive for the worker to skip a question rather than guess an answer to the question is that a skipped question does not reduce the payment. That is, the payment may be adjusted based on a multiplicative factor of one for skipped questions.

FIG. 6 illustrates that the worker may be incentivized to provide an honest assessment of their confidence level in a particular answer. For example, one incentive for the worker to provide an honest assessment of their confidence level is that an incorrect answer to a “gold standard” question with a high confidence level (e.g., “Absolutely Sure”) reduces the payment (e.g., to zero or by a significant factor). Another incentive for the worker to provide an honest assessment of their confidence level is that, while an incorrect answer to a “gold standard” question with a lower confidence level (e.g., “Moderately Sure”) may reduce the payment, the payment reduction may be less than a reduction associated with an incorrect answer with the high confidence level.

Referring to FIG. 6, an illustrative example of a task 602 includes a worker identifying the Golden Gate Bridge of San Francisco, Calif. in multiple photographs (e.g., 21 photographs in the particular embodiment of FIG. 6). In some cases, the user interface 600 may be displayed via a computing device (e.g., on the display device 1108 of the computing device 1100 of FIG. 11 described below). The user interface 600 may allow a worker to view instructions 604 that are associated with the task 602. In the example of FIG. 6, the instructions 604 indicate that there are three “gold standard” questions, and that a payment to the worker is based at least in part on the answers to these three “gold standard” questions. As in the example of FIG. 4, the instructions 604 indicate that the worker starts with a payment of 5.9 cents. The instructions 604 further indicate that, for each of the “gold standard” questions that the worker answers correctly, the payment may be adjusted based on a multiplicative factor that depends on a confidence level provided by the worker.

For example, in the embodiment of FIG. 6, an incorrect answer to one of the three “gold standard” questions with high confidence results in a payment to the worker being reduced to zero (or by a significant factor to incentivize the worker to refrain from providing an inflated confidence level). Further, in the embodiment of FIG. 6, an incorrect answer to one of the three “gold standard” questions with moderate confidence results in a payment to the worker being reduced by half.

In the particular embodiment illustrated in FIG. 6, a first multiplicative factor (e.g., 1.5) may be associated with the worker correctly answering a “gold standard” question with a high confidence level. To illustrate, the payment may be increased by 50% (i.e., multiplied by 1.5) for each “gold standard” question that the worker answers correctly with high confidence. FIG. 6 further illustrates that a second multiplicative factor (e.g., 1.4) may be associated with the worker correctly answering a “gold standard” question with a moderate confidence level. To illustrate, the payment may be increased by 40% (i.e., multiplied by 1.4) for each “gold standard” question that the worker answers correctly with moderate confidence. FIG. 6 further illustrates that a third multiplicative factor (e.g., 0.5) may be associated with the worker incorrectly answering a “gold standard” question with a moderate confidence level. To illustrate, the payment may be reduced by 50% (i.e., multiplied by 0.5) for each “gold standard” question that the worker answers incorrectly with moderate confidence. Thus, FIG. 6 illustrates another example of a multiplicative incentive mechanism that is based at least in part on a multiplicative component.

The user interface 600 of FIG. 6 shows a first question 612 (out of a total of 21 photograph identification questions associated with the task 602). In the example of FIG. 6, the first question 612 includes a first image 616 of a bridge. The first question 612 includes a first answer (i.e., “Golden Gate Bridge”) with multiple selectable confidence levels, including a first selectable confidence level 636 (i.e., “Absolutely Sure”) and a second selectable confidence level 638 (i.e., “Moderately Sure”). The first question 612 includes a second answer (i.e., “NOT Golden Gate Bridge”) with a first selectable confidence level 640 (i.e., “Absolutely Sure”) and a second selectable confidence level 642 (i.e., “Moderately Sure”). As in the example of FIG. 4, the first question 612 further includes a selectable option 644 to skip the question (e.g., an “I'm not sure” option). Further, in the embodiment illustrated in FIG. 6, the first question 612 also includes a warning 624 to indicate to the worker that a wrong answer may reduce the payment, encouraging the worker to use the “I'm not sure” option wisely. While FIG. 6 illustrates two selectable confidence levels, in alternative implementations, an alternative number of confidence levels may be presented for selection (e.g., more than two). As an illustrative, non-limiting example, a third confidence level could be presented for user selection, and different multiplicative factors could be associated with answering a particular question correctly/incorrectly with the third confidence level.

In the embodiment illustrated in FIG. 6, the user interface 600 includes a navigation bar 630, a first selectable control 632 to “scroll up” and a second selectable control 634 to “scroll down” (e.g., to view other questions that follow the first question 612). The worker may use the navigation bar 630, the first selectable control 632, the second selectable control 634, or a combination thereof in order to view and provide answers to each of the 21 questions that are associated with the task 602. Further, the worker may scroll up (e.g., via the navigation bar 630 or the first selectable control 632) to return to a particular question or review answers prior to submission.

In some embodiments, the three “gold standard” questions associated with the task 602 may be inserted randomly into the sequence of questions presented to the worker. Thus, the worker may have no way of knowing whether a particular question is a “gold standard” question. The exemplary multiplicative incentive mechanism of FIG. 6 may incentivize the worker to skip a particular question when the worker is not “confident enough” in the answer to justify the incentive payment being reduced to zero in the event that the worker answers the question incorrectly and the question is one of the “gold standard” questions.

As indicated in the instructions 604, a starting payment for the task 602 is 5.9 cents, which may be represented as K. However, the task 602 is not complete and no payment is made until the worker has provided a response to each of the 21 questions. Referring to the first question 612 as an example, the worker may choose to provide a first answer to the first question 612 (i.e., “Golden Gate Bridge”) with high confidence by selecting the first selectable confidence level 636 or with moderate confidence by selecting the second selectable confidence level 638. Alternatively, the worker may choose to provide a second answer to the first question 612 (i.e., “NOT Golden Gate Bridge”) with high confidence by selecting the first selectable confidence level 640 or with moderate confidence by selecting the second selectable confidence level 642. As another alternative, the worker may choose to skip the first question 612 by selecting the selectable option 644 labeled “I'm not sure” in FIG. 6. As in FIG. 4, the multiplicative incentive mechanism illustrated in FIG. 6 incentivizes the worker to skip a question if her confidence is below a confidence threshold (represented as T) and to answer the question if her confidence is greater than T.

The multiplicative incentive mechanism illustrated in FIG. 6 further incentivizes the worker to provide an honest assessment of her confidence level. For example, the worker may be incentivized to provide a first answer to the first question 612 (i.e., “Golden Gate Bridge”) with moderate confidence if her confidence is greater than T but less than a second confidence threshold (represented as T2). The worker may be incentivized to provide the first answer to the first question 612 (i.e., “Golden Gate Bridge”) with high confidence if her confidence is greater than T2. As another example, the worker may be incentivized to provide a second answer to the first question 612 (i.e., “NOT Golden Gate Bridge”) with moderate confidence if her confidence is greater than T but less than T2. The worker may be incentivized to provide the second answer to the first question 612 (i.e., “NOT Golden Gate Bridge”) with high confidence if her confidence is greater than T2.

For every correctly answered “gold standard” question, K may be multiplied by a particular multiplicative factor that may be determined based on whether the worker answered with high confidence or moderate confidence. If the worker answers even one “gold standard” question incorrectly with high confidence, K may be reduced to zero. However, FIG. 6 illustrates that for a “gold standard” question that the worker answers incorrectly with moderate confidence, K may be reduced by a third multiplicative factor (e.g., 0.5 in the example of FIG. 6). This difference in payment reduction may incentivize workers to provide an honest assessment of their confidence level.

Referring to the first question 612 of FIG. 6 as an example, if the worker's confidence that the bridge illustrated in the first image 616 is the Golden Gate Bridge is above the confidence threshold T2, the worker may provide the first answer (i.e., “Golden Gate Bridge”) with high confidence by selecting the first selectable confidence level 636. However, if the worker's confidence is above the confidence threshold T but below T2, the worker may be incentivized to provide the first answer with moderate confidence by selecting the second selectable confidence level 638. That is, if the worker is moderately sure but not absolutely sure that the bridge is the Golden Gate Bridge, the worker may choose to forego some potential payment increase in order to reduce the potential payment reduction in the event that the worker's answer is incorrect.

As another example, if the worker's confidence that the illustrated bridge is not the Golden Gate Bridge is above the confidence threshold T2, the worker may provide the second answer (i.e., “NOT Golden Gate Bridge”) with high confidence by selecting the first selectable confidence level 640. However, if the worker's confidence that the bridge is not the Golden Gate Bridge is above the confidence threshold T but below T2, the worker may be incentivized to provide the second answer with moderate confidence by selecting the second selectable confidence level 642. That is, if the worker is moderately sure but not absolutely sure that the bridge is not the Golden Gate Bridge, the worker may choose to forego some potential payment increase in order to reduce the potential payment reduction in the event that the worker's answer is incorrect.

Alternatively, if the worker's confidence regarding whether the bridge is the Golden Gate Bridge is below the confidence threshold T, the worker may be incentivized to skip the first question 612 by selecting the selectable option 644 (i.e., “I'm not sure”).

For illustrative purposes only, the first question 612 of FIG. 6 may be one of the three “gold standard” questions associated with the task 602. In the event that the worker elects to skip the first question 612 by selecting the selectable option 644 (i.e., “I'm not sure”), the payment is not reduced. That is, the starting payment K may remain at 5.9 cents.

In the event that the worker correctly answers the first question 612 by selecting the first answer (i.e., “Golden Gate Bridge”) with high confidence, the starting payment K (e.g., 5.9 cents in this case) may be multiplied by the first multiplicative factor (e.g., 1.5 in this case). That is, the payment may be adjusted from 5.9 cents to 8.9 cents (i.e., 5.9 cents*1.5=8.9 cents). However, according to the particular multiplicative incentive mechanism of FIG. 6 that allows the worker to identify a confidence level, in the event that the worker correctly answers the first question 612 with moderate confidence, the starting payment K may be multiplied by the second multiplicative factor (e.g., 1.4 in this case). That is, the payment may be adjusted from 5.9 cents to 8.3 cents (i.e., 5.9 cents*1.4=8.3 cents).

In the event that the worker incorrectly answers the first question 612 by selecting the second answer (i.e., “NOT Golden Gate Bridge”) with high confidence, the starting payment K may be reduced to zero. However, according to the particular multiplicative incentive mechanism of FIG. 6 that allows the worker to identify a confidence level, in the event that the worker incorrectly answers the first question 612 by selecting the second answer (i.e., “NOT Golden Gate Bridge”) with moderate confidence, the starting payment K may be reduced by the third multiplicative factor (e.g., 0.5 in this case). That is, the payment may be adjusted from 5.9 cents to 3 cents (i.e., 5.9 cents*0.5=3 cents).

Thus, the exemplary multiplicative incentive mechanism of FIG. 6 may encourage workers to be honest by incentivizing the workers to answer questions with an appropriate confidence level when they are at least moderately sure that they know the answer and to skip questions when they are not confident that they know the answer. Further, the possibility of a significant reduction or elimination of the payment for incorrect answers may encourage workers to be more careful when answering questions and may discourage spammers or miscreants from performing a task. Still further, the multiplicative nature of the payment determination may encourage some workers to perform additional research in order to determine whether to answer or skip a particular question.

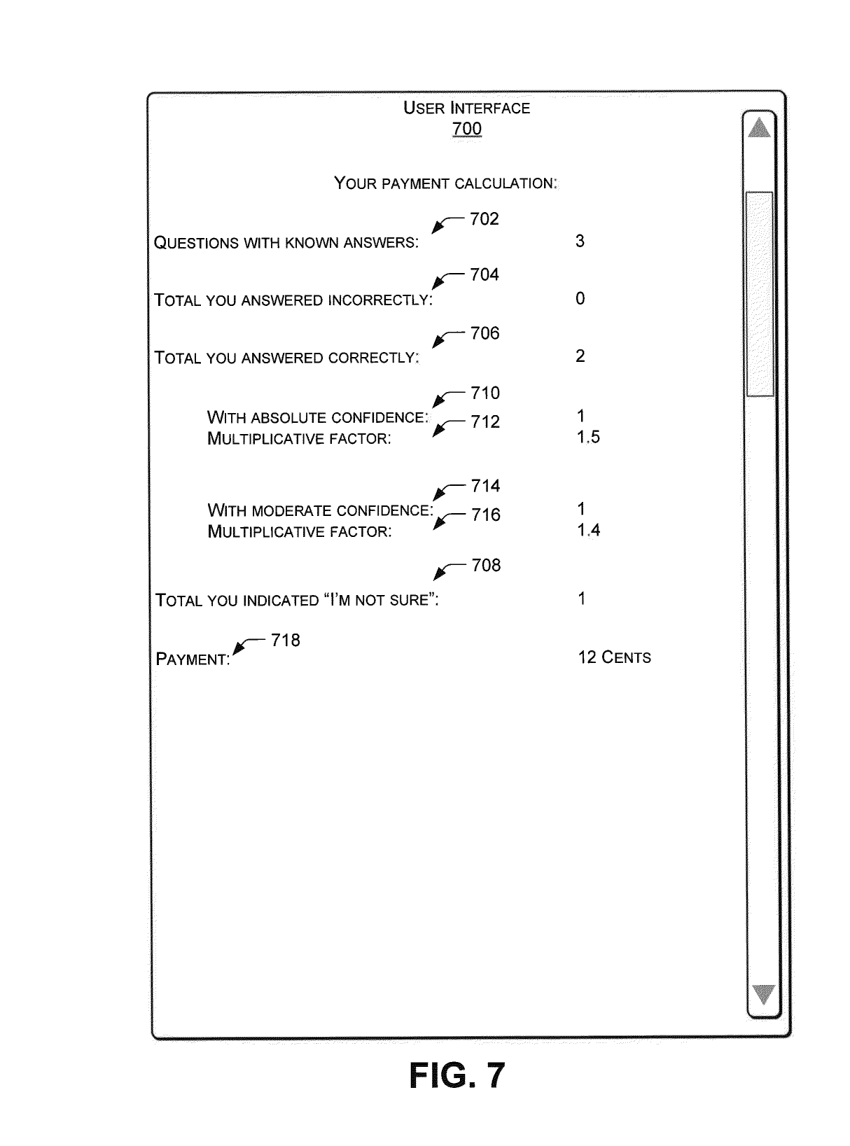

Referring to FIG. 7, an example of a user interface 700 that may be presented after completion of the task 602 in FIG. 6 is illustrated. The user interface 700 may provide information to the worker regarding the payment associated with the task 602.

In the embodiment illustrated in FIG. 7, the user interface 700 identifies a number of questions with known answers that are associated with the task 602 (i.e., the “gold standard” questions), as shown at 702. In this case, the number of “gold standard” questions is three. The user interface 700 also identifies a number of “gold standard” questions that the worker answered incorrectly, as shown at 704. For illustrative purposes only, FIG. 7 shows that the worker has answered none of the three “gold standard” questions incorrectly. The user interface 700 also identifies a number of “gold standard” questions that the worker answered correctly, as shown at 706. For illustrative purposes only, FIG. 7 shows that the worker has answered two of the three questions correctly. The user interface 700 of FIG. 7 also illustrates a number of skipped “gold standard” questions (i.e., the number of questions where the user selected the “I'm not sure” option 644 illustrated in FIG. 6), as shown at 708. For illustrative purposes only, FIG. 7 shows that the worker has skipped one of the three “gold standard” questions.

As indicated in the instructions 604 associated with the task 602 (see FIG. 6), a payment to the worker may be determined based not only on the number of “gold standard” questions that the worker answered correctly but also the associated confidence levels provided by the worker. Accordingly, the exemplary user interface 700 of FIG. 7 provides additional information with respect to the “gold standard” questions that the worker answered correctly. For illustrative purposes only, FIG. 7 shows that the worker has answered one of the “gold standard” questions with absolute confidence, as shown at 710. FIG. 7 also shows the first multiplicative factor (e.g., 1.5 as shown in FIG. 6) that is associated with correctly answering a “gold standard” question with absolute confidence, at 712. For illustrative purposes only, FIG. 7 shows that the worker has answered one of the “gold standard” questions with moderate confidence, as shown at 714. FIG. 7 also shows the second multiplicative factor (e.g., 1.4 as shown in FIG. 6) that is associated with correctly answering a “gold standard” question with moderate confidence, at 716. In the example illustrated in FIG. 7, the worker has not incorrectly answered any “gold standard” questions with moderate confidence. Accordingly, the example of FIG. 7 does not illustrate the third multiplicative factor (e.g., 0.5 as shown in FIG. 6) that is associated with incorrectly answering a “gold standard” question with moderate confidence. However, it will be appreciated that in alternative scenarios where the worker incorrectly answered one or more of the “gold standard” questions with moderate confidence, the user interface 700 may display the third multiplicative factor (e.g., as a sub-heading under the total number of “gold standard” questions that were answered incorrectly (as shown at 704).

Thus, in the example of FIG. 7, a payment 718 is multiplicative and is determined based on the number of correctly answered “gold standard” questions (i.e., 2), the confidence levels provided by the worker when answering the “gold standard” questions (i.e., one with absolute confidence and one with moderate confidence), and the multiplicative factors associated with answering the questions with the different levels of confidence. To illustrate, the payment 718 may be calculated as follows. A starting payment (e.g., 5.9 cents) may be adjusted in response to the first correctly answered “gold standard” question.

As an illustrative, non-limiting example, referring to FIG. 6, the first question 612 may represent the first of the three “gold standard” questions, with the correct answer provided by the worker with high confidence. As such, the starting payment of 5.9 cents may be adjusted using the first multiplicative factor 712 (i.e., 5.9*1.5^{N}, with N being 1 in this case), resulting in a payment increase from 5.9 cents to 8.9 cents. The other “gold standard” question that was answered correctly with moderate confidence may be one of the other 20 questions associated with the task 602 that follow the first question 612. As such, the payment amount may be adjusted from 8.9 cents may be adjusted using the second multiplicative factor 716 (i.e., 8.9*1.4^{N}, with N being 1 in this case), resulting in a payment increase from 8.9 cents to 12 cents.

Thus, in the example of FIG. 7, the payment 718 is based at least in part on a multiplicative component (i.e., the payment 712 does not include an additive component associated with a non-zero minimum payment).

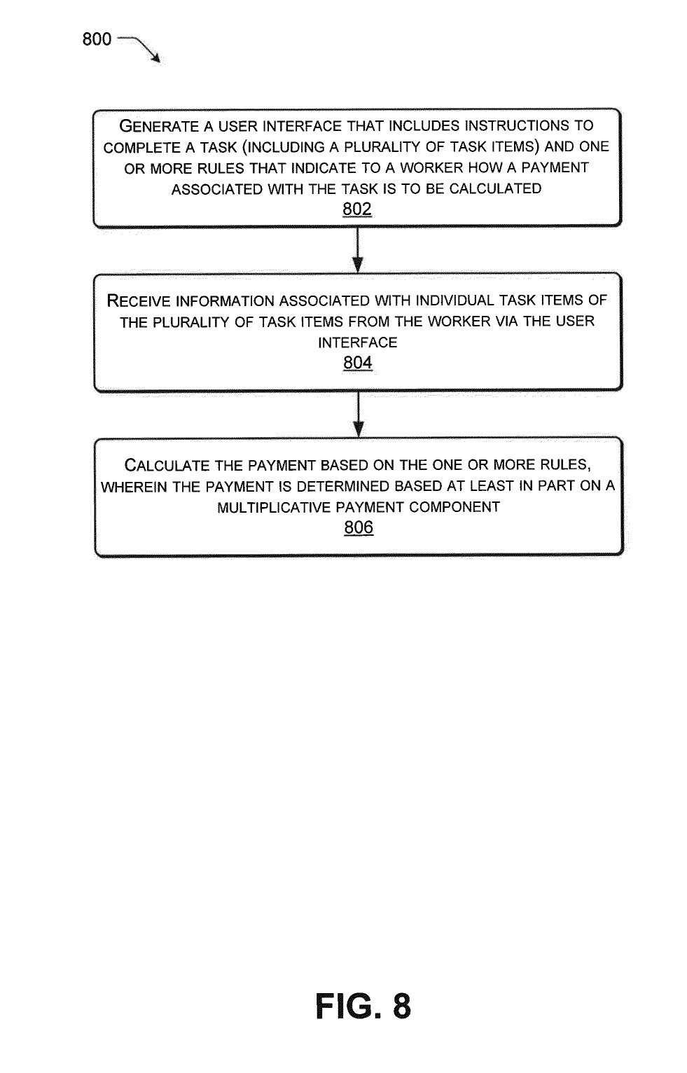

Referring to FIG. 8, an example process associated with an exemplary multiplicative incentive mechanism is illustrated and generally designated 800.

At 802, the process 800 includes generating a user interface that includes instructions to complete a task (including a plurality of task items) and one or more rules that indicate to a worker how a payment associated with the task is to be calculated. For example, referring to FIG. 1, the user interface 100 includes the instructions 104 associated with the task 102 (that includes identifying the Golden Gate Bridge of San Francisco, Calif. in 21 photographs). Further, the instructions 104 indicate to the worker how a payment associated with the task 102 is to be calculated. For example, the instructions 104 indicate that the payment for the task 102 is to be calculated based on the answers received from the worker for each of the three questions with known answers (of the 21 total questions associated with the task 102). That is, for each of the three “gold standard” questions that are answered correctly, the worker's payment is to be adjusted based on the multiplicative factor 108 (i.e., 1.5 in the example of FIG. 1).

Further, the instructions 104 provide a warning to the worker that “a wrong answer to a question whose answer is known will reduce your payment, so please answer carefully.” Still further, both the first question 112 and the second question 114 include the warning 124 that a wrong answer may reduce the worker's payment. Referring to the instructions 104, the task 102 includes the minimum payment 106 (i.e., two cents in the example of FIG. 1), with the maximum payment 110 determined based on a combination of the minimum payment 106 and a multiplicative component (i.e., 2*1.5^{N}), with N=3 in the case where the worker answers each of the three “gold standard” questions correctly.

At 804, the process 800 includes receiving information associated with individual task items of the plurality of task items from the worker via the user interface. For example, referring to FIGS. 1-3, the worker may answer each of the 21 questions associated with the task 102. In some cases, the user interface 300 may be displayed in response to the worker completing the task 102 (i.e., answering each of the 21 questions).

At 806, the process 800 includes calculating the payment based on the one or more rules, where the payment is determined based at least in part on a multiplicative payment component. To illustrate, referring to the user interface 300 of FIG. 3, the total payment 310 includes 9 cents, which represents a combination of the minimum payment 106 (i.e., two cents) and the “incentive” payment 308 (i.e., 7 cents). That is, the “incentive” payment 308 represents a multiplicative component of the total payment 310 (i.e., 2*1.5^{N}), with N=3 in the case where the worker answers each of the three “gold standard” questions correctly.

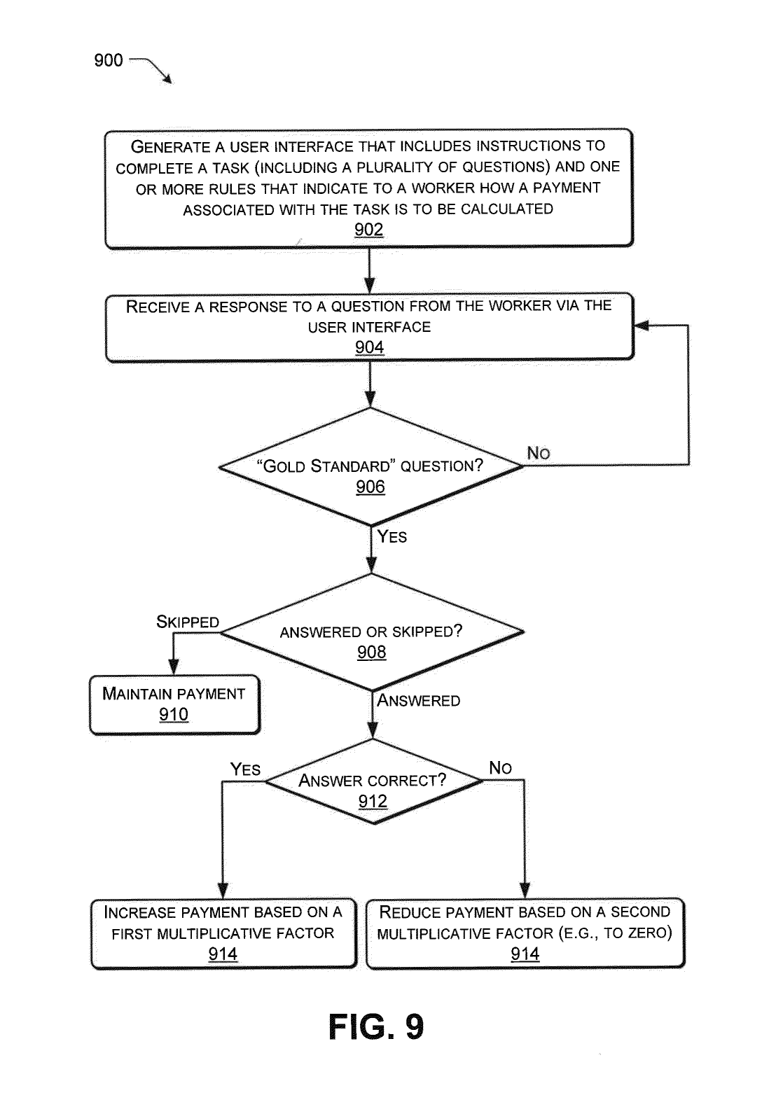

Referring to FIG. 9, an example process associated with another exemplary multiplicative incentive mechanism (that includes a skip option) is illustrated and generally designated 900.

At 902, the process 900 includes generating a user interface that includes instructions to complete a task (including a plurality of task items, such as multiple choice questions) and one or more rules that indicate to a worker how a payment associated with the task is to be calculated. For example, referring to FIG. 4, the user interface 400 includes the instructions 404 associated with the task 402 (that includes identifying the Golden Gate Bridge of San Francisco, Calif. in 21 photographs). Further, the instructions 404 indicate to the worker how a payment associated with the task 402 is to be calculated. For example, the instructions 404 indicate that the payment for the task 402 is to be calculated based on the answers received from the worker for each of the three questions with known answers (of the 21 total questions associated with the task 402). That is, for each of the three “gold standard” questions that are answered correctly, the worker's payment is to be adjusted based on the multiplicative factor 408 (i.e., 1.5 in the example of FIG. 1).

Further, the instructions 404 provide a warning to the worker that a wrong answer to a question whose answer is known will reduce the worker's payment to zero. In FIG. 4, the worker is provided with an option to skip a question that she does not know the answer by selecting the selectable option 436 (“I'm not sure”). The instructions 404 further indicate to the worker that skipping a question does not affect the payment. Referring to the instructions 404, the task 402 identifies a maximum payment 410 that is determined based on a multiplicative component (i.e., 5.9*1.5^{N}), with N=3 in the case where the worker answers each of the three “gold standard” questions correctly.

At 904, the process 900 includes receiving a response to a question from the worker via the user interface. For example, referring to FIGS. 4 and 5, the worker may provide a response (e.g., either answer or skip) to one of the 21 questions associated with the task 402 via the user interface 400. At 906, the process 900 includes determining whether the question is one of the “gold standard” questions. If the question is not one of the “gold standard” questions, the process 900 may including returning to step 904 to wait to receive a response to another question from the worker via the user interface.

If the question is determined to be one of the “gold standard” questions, at 906, the process 900 may include determining whether the worker answered the “gold standard” question or skipped the “gold standard” question, at 908.

If the question was skipped, the process 900 may include maintaining a payment, at 910. To illustrate, referring to FIG. 4, the instructions 404 indicate that the worker starts with a payment of 5.9 cents. In the event that the worker selects the selectable option 436 to skip the first question 412 (e.g., an “I'm not sure” option), the starting payment of 5.9 cents may be maintained. That is, the payment may be adjusted based on a multiplicative factor of one for the skipped question. Thus, FIG. 9 illustrates one incentive based mechanism to improve overall data quality by incentivizing the worker to skip a question rather than guess an answer to the question, because skipping a question does not reduce the payment to the worker.

If the question was answered, the process 900 may include determining whether the answer was correct, at 912. To illustrate, referring to FIG. 4, the correct answer to the first question 412 is the first selectable answer 420 (i.e., “Golden Gate Bridge”). If the worker selected the first selectable answer 420, the process 900 includes increasing a payment by a first multiplicative factor, at 914. If the worker selected the incorrect answer (i.e., the second selectable answer 422 (i.e., “NOT Golden Gate Bridge”), the process 900 may include reducing a payment by a second multiplicative factor (e.g., to zero), at 916. While not illustrated in the example of FIG. 9, in alternative embodiments, the process 900 may include significantly reducing a payment in response to an incorrect answer to a “gold standard” question using another multiplicative factor (e.g., a factor of 1/20, among other alternatives).

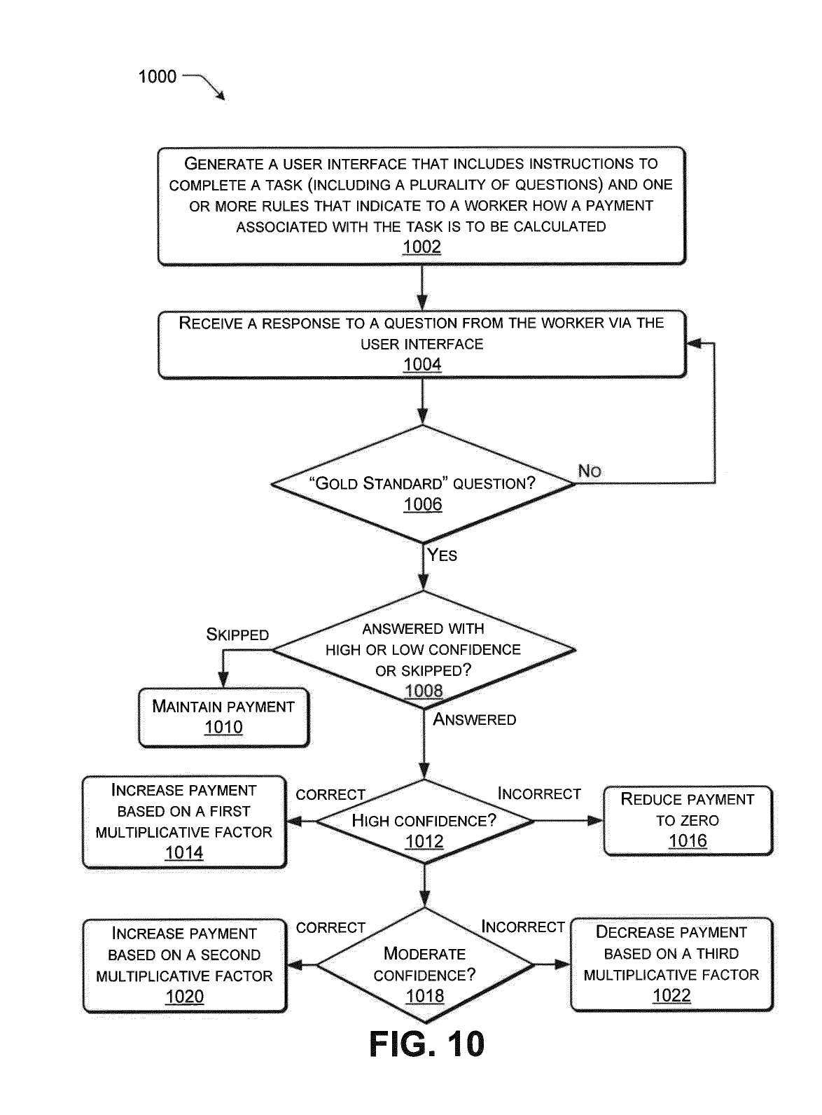

Referring to FIG. 10, an example process associated with another exemplary multiplicative incentive mechanism (that includes a skip option and a confidence assessment) is illustrated and generally designated 1000.

At 1002, the process 1000 includes generating a user interface that includes instructions to complete a task (including a plurality of task items, such as multiple choice questions) and one or more rules that indicate to a worker how a payment associated with the task is to be calculated. For example, referring to FIG. 6, the user interface 600 includes the instructions 604 associated with the task 402 (that includes identifying the Golden Gate Bridge of San Francisco, Calif. in 21 photographs). Further, the instructions 604 indicate to the worker how a payment associated with the task 602 is to be calculated. For example, the instructions 604 indicate that the payment for the task 602 is to be calculated based on the answers received from the worker for each of the three questions with known answers (of the 21 total questions associated with the task 602). That is, for each of the three “gold standard” questions that are answered correctly, the worker's payment is to be adjusted based on a first multiplicative factor 712 associated with identifying a correct answer with high confidence (i.e., 1.5 in the example of FIG. 6) or based on a second multiplicative factor 716 associated with identifying a correct answer with moderate confidence (i.e., 1.4 in the example of FIG. 6).

At 1004, the process 1000 includes receiving a response to a question from the worker via the user interface. For example, referring to FIGS. 6 and 7, the worker may provide a response (e.g., either answer with high confidence, answer with moderate confidence, or skip) to one of the 21 questions associated with the task 602 via the user interface 600. At 1006, the process 900 includes determining whether the question is one of the “gold standard” questions. If the question is not one of the “gold standard” questions, the process 1000 may including returning to step 1004 to wait to receive a response to another question from the worker via the user interface.

If the question is determined to be one of the “gold standard” questions, at 1006, the process 1000 may include determining whether the worker answered the “gold standard” question with high confidence, answered the “gold standard” question with moderate confidence, or skipped the “gold standard” question, at 1008.

If the question was skipped, the process 1000 may include maintaining a payment, at 1010. To illustrate, referring to FIG. 6, the instructions 604 indicate that the worker starts with a payment of 5.9 cents. In the event that the worker selects the selectable option 644 to skip the first question 612 (e.g., an “I'm not sure” option), the starting payment of 5.9 cents may be maintained. That is, the payment may be adjusted based on a multiplicative factor of one for the skipped question. Thus, FIG. 10 illustrates one incentive based mechanism to improve overall data quality by incentivizing the worker to skip a question rather than guess an answer to the question, because skipping a question does not reduce the payment to the worker.

If the question was answered, the process 1000 may include determining whether the worker provided a high confidence when providing the answer, at 1012. To illustrate, referring to FIG. 6, the worker may provide the first answer (i.e., “Golden Gate Bridge”) with a first selectable confidence level 636 (i.e., “Absolutely Sure”). Alternatively, the worker may provide the second answer (i.e., “NOT Golden Gate Bridge”) with a first selectable confidence level 640 (i.e., “Absolutely Sure”). In the event that the worker submits the correct answer (i.e., “Golden Gate Bridge”), the process 1000 may include increasing the payment by a first multiplicative factor (e.g., 1.5), at 1014. In the event that the worker submits the incorrect answer (i.e., “NOT Golden Gate Bridge”), the process 1000 may include reducing the payment to zero, at 1016.

If the question was answered, the process 1000 may include determining whether the worker provided a moderate confidence when providing the answer, at 1018. To illustrate, referring to FIG. 6, the worker may provide the first answer (i.e., “Golden Gate Bridge”) with a second selectable confidence level 638 (i.e., “Moderately Sure”). Alternatively, the worker may provide the second answer (i.e., “NOT Golden Gate Bridge”) with a second selectable confidence level 642 (i.e., “Moderately Sure”). In the event that the worker submits the correct answer (i.e., “Golden Gate Bridge”), the process 1000 may include increasing the payment by a second multiplicative factor (e.g., 1.4), at 1020. In the event that the worker submits the incorrect answer (i.e., “NOT Golden Gate Bridge”), the process 1000 may include reducing the payment to zero, at 1016.

In the event that the worker submits the correct answer (i.e., “Golden Gate Bridge”) with a moderate confidence, the process 1000 may include increasing the payment by a second multiplicative factor (e.g., 1.4), at 1022. In the event that the worker submits the incorrect answer (i.e., “NOT Golden Gate Bridge”), the process 1000 may include decreasing the payment by a third multiplicative factor (e.g., 1.4), at 1022.

### Example Computing Device and Environment

FIG. 11 illustrates an example configuration of a computing device 1100 and an environment that can be used to implement the modules and functions described herein.

The computing device 1100 may include at least one processor 1102, a memory 1104, communication interfaces 1106, a display device 1108 (e.g. a touchscreen display), other input/output (I/O) devices 1110 (e.g. a touchscreen display or a mouse and keyboard), and one or more mass storage devices 1112, able to communicate with each other, such as via a system bus 1114 or other suitable connection.

The processor 1102 may be a single processing unit or a number of processing units, all of which may include single or multiple computing units or multiple cores. The processor 1102 can be implemented as one or more microprocessors, microcomputers, microcontrollers, digital signal processors, central processing units, state machines, logic circuitries, and/or any devices that manipulate signals based on operational instructions. Among other capabilities, the processor 1102 can be configured to fetch and execute computer-readable instructions stored in the memory 1104, mass storage devices 1112, or other computer-readable media.

Memory 1104 and mass storage devices 1112 are examples of computer storage media for storing instructions which are executed by the processor 1102 to perform the various functions described above. For example, memory 1104 may generally include both volatile memory and non-volatile memory (e.g., RAM, ROM, or the like). Further, mass storage devices 1112 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 1104 and mass storage devices 1112 may be collectively referred to as memory or computer storage media herein, and may be computer-readable media capable of storing computer-readable, processor-executable program instructions as computer program code that can be executed by the processor 1102 as a particular machine configured for carrying out the operations and functions described in the implementations herein.

The computing device 1100 may also include one or more communication interfaces 1106 for exchanging data with other devices, such as via a network, direct connection, or the like, as discussed above. The communication interfaces 1106 can facilitate communications within a wide variety of networks and protocol types, including wired networks (e.g., LAN, cable, etc.) and wireless networks (e.g., WLAN, cellular, satellite, etc.), the Internet and the like. Communication interfaces 1106 can also provide communication with external storage (not shown), such as in a storage array, network attached storage, storage area network, or the like.

The discussion herein refers to data being sent and received by particular components or modules. This may not be taken as a limitation as such communication need not be direct and the particular components or module need not necessarily be a single functional unit. This is not to be taken as limiting implementations to only those in which the components directly send and receive data from one another. The signals could instead be relayed by a separate component upon receipt of the data. Further, the components may be combined or the functionality may be separated amongst components in various manners not limited to those discussed above. Other variations in the logical and practical structure and framework of various implementations would be apparent to one of ordinary skill in the art in view of the disclosure provided herein.

A display device 1108, such as touchscreen display or other display device, may be included in some implementations. Other I/O devices 1110 may be devices that receive various inputs from a user and provide various outputs to the user, and may include a touchscreen, such as a touchscreen display, a keyboard, a remote controller, a mouse, a printer, audio input/output devices, and so forth.

Memory 1104 may include modules and components for execution by the computing device 1100 according to the implementations discussed herein. In the illustrated example, memory 1104 includes a multiplicative incentive module 1114 to perform one or more of the operations described above. Memory 1104 may further include one or more other modules 1116, such as an operating system, drivers, application software, communication software, or the like. Memory 1104 may also include other data 1118, such as data stored while performing the functions described above and data used by the other modules 1116. Memory 1104 may also include other data and data structures described or alluded to herein.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Although illustrated in FIG. 11 as being stored in memory 1104 of computing device 1100, the multiplicative incentive module 1114, or portions thereof, may be implemented using any form of computer-readable media that is accessible by computing device 1100. As used herein, “computer-readable media” includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media comprises computer readable instructions, data structures, program modules, or other data in a modulated data signal, such as a carrier wave, or other transmission mechanism. As defined herein, computer storage media does not include communication media.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method comprising:
under control of one or more computing devices:
causing a user interface to be served that includes:
instructions to complete a task, the task including a plurality of task items; and
one or more rules that indicate to a worker that a payment associated with the task is to be calculated;
receiving information associated with individual task items of the plurality of task items from the worker via the user interface; and
calculating the payment based on the received information and according to the one or more rules, wherein the payment is determined based at least in part on a multiplicative payment component.

2. The method of claim 1, wherein:
the plurality of task items includes a plurality of questions;
the user interface presents at least a first selectable answer and a second selectable answer for individual questions of the plurality of questions;
the one or more rules indicate to the worker that a correct answer to at least one question of the plurality of questions is known; and
the one or more rules indicate to the worker that the multiplicative payment component is determined based at least in part on a multiplicative factor and whether the worker responded to the at least one question with the correct answer.

3. The method of claim 2, wherein:
the user interface further presents a selectable skip option for individual questions of the plurality of questions; and
the one or more rules indicate to the worker that the multiplicative payment component is not reduced when the worker selects the selectable skip option for the at least one question with the known correct answer.

4. The method of claim 2, wherein the multiplicative payment component is reduced in response to determining that the worker responded incorrectly to the at least one question with the known correct answer.

5. The method of claim 2, wherein the multiplicative payment component is reduced to zero in response to determining that the worker responded incorrectly to the at least one question with the known correct answer.

6. The method of claim 1, wherein:
the plurality of task items includes a plurality of questions;
the one or more rules indicate to the worker that a correct answer to at least one question of the plurality of questions is known;
the user interface presents a selectable skip option for individual questions of the plurality of questions;

7. The method of claim 6, wherein the one or more rules further indicate to the worker that the multiplicative payment component is not reduced when the worker selects the selectable skip option for the at least one question having the known correct answer.

8. The method of claim 6, wherein the user interface further presents multiple selectable confidence levels associated with submitting a particular answer for the individual questions, the multiple selectable confidence levels including at least a first selectable confidence level and a second selectable confidence level.

9. The method of claim 8, wherein the one or more rules further indicate to the worker that the multiplicative payment component is reduced to zero when the worker responds incorrectly to the at least one question having the known correct answer with the first selectable confidence level.

10. The method of claim 9, wherein the one or more rules further indicate to the worker that the multiplicative payment component is determined based at least in part on:
a first multiplicative factor when the worker responds correctly to the at least one question having the known correct answer with the first selectable confidence level;
a second multiplicative factor when the worker responds correctly to the at least one question having the known correct answer with the second selectable confidence level; and
a third multiplicative factor when the worker responds incorrectly to the at least one question having the known correct answer with the second selectable confidence level.

11. The method of claim 10, wherein the first selectable confidence level represents a higher confidence level than the second selectable confidence level.

12. The method of claim 11, wherein:
the first multiplicative factor is greater than one; and
the second multiplicative factor is greater than one but less than the first multiplicative factor.

13. The method of claim 11, wherein the third multiplicative factor is greater than zero but less than one.

14. The method of claim 1, wherein:
the payment includes the multiplicative payment component; and
a fixed minimum payment amount that is greater than zero.

15. A computing system comprising:
one or more processors;
one or more computer readable media maintaining instructions that, when executed by the one or more processors, cause the one or more processors to perform acts comprising:
generating a user interface that includes:
instructions to complete a task, the task including a plurality of questions;
at least a first selectable answer and a second selectable answer for individual questions of the plurality of questions; and
one or more rules that indicate that:
a correct answer to at least one question of the plurality of questions is known; and
a multiplicative payment component of a payment associated with the task is to be calculated based at least in part on one or more multiplicative factors and whether a worker responded to the at least one question with the known correct answer; and
calculating the payment based at least in part on responses to the individual questions and the one or more rules.

16. The computing system of claim 15, wherein:
the user interface further includes a selectable skip option for individual questions of the plurality of questions; and
the one or more rules further indicate that the multiplicative payment component is not reduced when the selectable skip option is selected for the at least one question with the known correct answer.

17. The computing system of claim 16, wherein:
the user interface further includes multiple selectable confidence levels associated with submitting a particular answer for individual questions of the plurality of questions;
the one or more rules further indicate to the worker that the multiplicative payment component is:
increased based on a first multiplicative factor when the worker responds correctly to the at least one question with a first confidence level;
increased based on a second multiplicative factor when the worker responds correctly to the at least one question with a second confidence level, wherein the second multiplicative factor is greater than one but less than the first multiplicative factor;
decreased based on a third multiplicative factor when the worker responds correctly to the at least one question with the second confidence level, wherein the third multiplicative factor is greater than zero but less than one; and
decreased based a fourth multiplicative factor when the worker responds incorrectly to the at least one question with the first confidence level, wherein the fourth multiplicative factor is less than the third multiplicative factor.

18. One or more computer-readable media maintaining instructions that, when executed by one or more processors, cause the one or more processors to perform acts comprising:
generating a user interface that includes:
instructions to complete a task, the task including a plurality of task items; and
one or more rules that indicate that a payment associated with the task is to be calculated according to a multiplicative payment function;
receiving information associated with individual task items of the plurality of task items via the user interface; and
calculating the payment based on the one or more rules, wherein the payment is determined based at least in part on the multiplicative payment function.

19. The one or more computer-readable media of claim 18, wherein:
the user interface further presents a selectable skip option for individual task items of the plurality of task items; and
the one or more rules further indicate that the multiplicative payment component is not reduced when the selectable skip option is selected.

20. The one or more computer-readable media of claim 18, wherein:
the plurality of task items includes a plurality of questions;
the user interface further presents a selectable skip option and multiple selectable confidence levels associated with submitting a particular answer for individual questions of the plurality of questions; and
the one or more rules further indicate that:
a correct answer to at least one question of the plurality of questions is known;
the multiplicative payment component is not reduced when the worker selects the selectable skip option for the at least one question for which the correct answer is known;
the multiplicative payment component is reduced to zero when the worker responds incorrectly to the at least one question for which the correct answer is known with a first selectable confidence level; and
the multiplicative payment component is determined based at least in part on:
a first multiplicative factor when the worker responds correctly to the at least one question for which the correct answer is known with the first selectable confidence level;
a second multiplicative factor when the worker responds correctly to the at least one question for which the correct answer is known with a second selectable confidence level; and
a third multiplicative factor when the worker responds incorrectly to the at least one question for which the correct answer is known with the second selectable confidence level.
